(19) United States
(12) Patent Application Publication
(10) Pub. No.: US 2018/0368438 A1
(43) Pub. Date: Dec. 27, 2018

(54) Process for the production of sugar-free Ice Cream

(71) Applicant: Deutsches Institut fuer Lebensmitteltechnik e.V., Quakenbrueck (DE)

(72) Inventors: Ute Bindrich, Quakenbrueck (DE); Josef Frieling, Quakenbrueck (DE)

(21) Appl. No.: 16/014,708

(22) Filed: Jun. 21, 2018

(30) Foreign Application Priority Data
Jun. 22, 2017 (DE) 10 2017 210 525.9

(51) Int. Cl. A23G 9/20; A23G 9/32; A23G 9/22; A23G 9/28; A23G 9/38; A23G 9/34; A23G 9/46; A23K 50/40; A23K 40/25

(52) U.S. Cl. CPC A23G 9/20; A23V 2250/64; A23G 9/224; A23G 9/285; A23G 9/38; A23G 9/34; A23G 9/46; A23K 50/40; A23K 40/25; A23V 2002/00; A23V 2200/222; A23V 2300/38; A23V 2250/5432; A23V 2250/548; A23V 2250/5424; A23V 2250/5114; A23G 9/327

(57) ABSTRACT

The invention relates to a process for producing ice-cream which is free from sugar, especially contains less than 1 wt.-%, preferably less than 0.5 wt.-% sugar, which especially comprises glucose, sucrose, fructose, lactose and maltose. Further, the invention relates to ice-cream produced by the process.

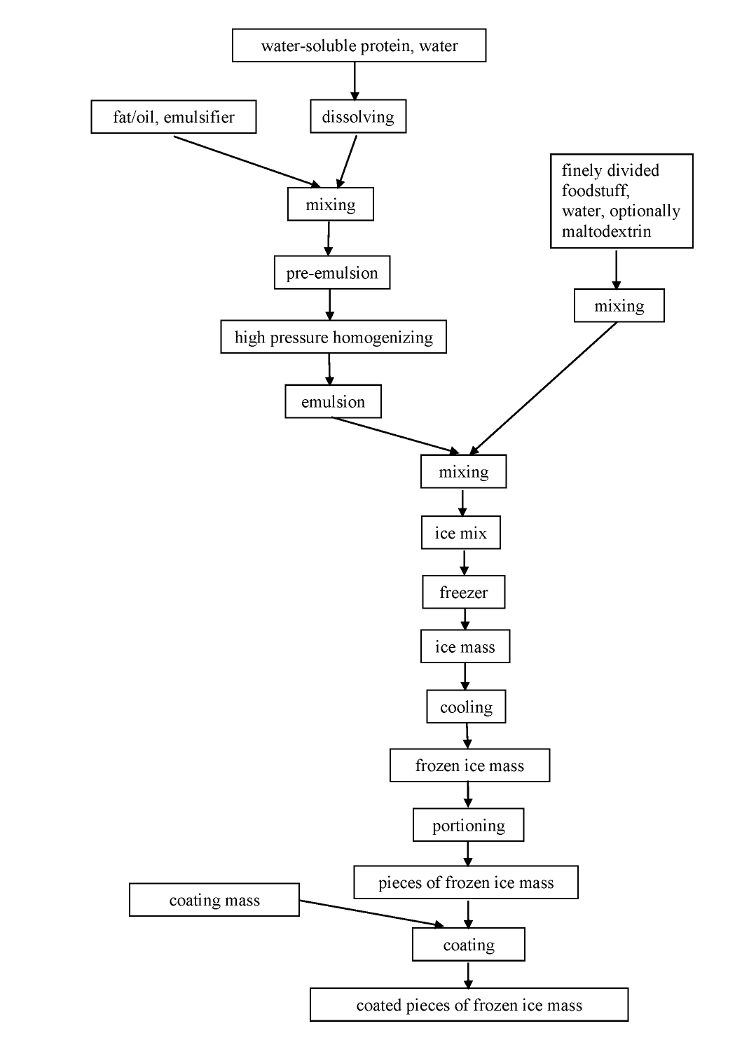

The invention relates to a process for the production of ice-cream, which is free from sugar, especially contains less than 1 wt.-%, preferably less than 0.5 wt.-% sugar, which especially comprises glucose, sucrose, fructose, lactose and maltose. Further, the invention relates to ice-cream produced by the process.

The process has the advantage that the ice-cream reduced thereby has a low sugar content, respectively is free from sugar, and further preferably contains a low proportion of sugars substitutes like sugar alcohols, e.g. contains at maximum 1 wt.-%, and even more preferably is free from sugar substitutes, e.g. free from sugar alcohols.

### STATE OF THE ART

It is known to produce ice-cream from a liquid ice mix which for depression of the freezing point contains sugar, especially sucrose, optionally alcohol, and to provide this ice mix with overrun by introducing air in a freezer having a moving scraper within a cooling jacket and to freeze it for producing an ice mass which is subsequently hardened by further cooling.

### OBJECT OF THE INVENTION

It is the object of the invention to provide an alternative process for producing ice-cream in which the ice mix contains less than 1 wt.-% sugar. Preferably the process shall be conducted without the addition of ingredients causing a depression of the freezing point.

### DESCRIPTION OF THE INVENTION

The invention achieves the object by the features of the claims, especially by a process for producing ice-cream having the steps
producing a pre-emulsion which contains or consists of at least one water-soluble protein, water, at least one fat and at least one emulsifier, optionally a colorant,
high pressure emulsifying the pre-emulsion by releasing a pressure difference of at least 1,500 bar, preferably at least 1,800 bar or at least 2,000 bar, more preferred up to 4,000 bar, even more preferred 2,500 to 3,500 bar, e.g. 2,500 to 3,000 bar, for producing an emulsion,
mixing the emulsion with at least one finely divided foodstuff, which optionally can be contained in a mixture, which contains or consists of the at least one finely divided foodstuff, which preferably is admixed and/or finely divided or dissolved in water, preferably maltodextrin and optionally a colorant, for producing an ice mix, wherein optionally the finely divided foodstuff, optionally in admixture with water, is pasteurized prior to mixing with the emulsion,
optionally pasteurizing the ice mix,
cooling the ice mix under agitation, especially by scraping of the ice mix from a cooling surface, preferably with introduction of gas, for producing an ice mass,
with subsequent further cooling of the ice mass, preferably by means of a cooled planetary roller extruder, for producing a frozen ice mass,
preferably portioning the frozen ice mass for producing pieces from the frozen ice mass,
optionally including coating the pieces of the frozen ice mass, preferably with water only, or with an aqueous mixture as a coating mass, which e.g. can be the same as the pre-emulsion, a mixture of at least one finely divided foodstuff in water, optionally with maltodextrin, or can be equal to the ice mix, optionally with addition of a colorant, with subsequent cooling.

The mixing of the components of the pre-emulsion can e.g. be made by stirring or by low pressure homogenizing.

The pre-emulsion can be produced by mixing of its ingredients, e.g. by means of a stirrer or mixer, e.g. by means of pumping through a static mixer, by means of a stirring device, a rotor-stator-mixer or a turbine mixer, e.g. at 750 to 1000 rpm and/or by means of a low pressure homogenizer. The mixing preferably has an effect corresponding to the mixing by means of an Ultra-Turrax at 2,000 to 3,000 rpm. Preferably, the pre-emulsion is produced by
dissolving the at least one water-soluble protein in water for producing an aqueous protein solution and
admixing the fat and the emulsifier to the aqueous protein solution and mixing,
   wherein optionally colorant is added into the water or into the aqueous protein solution.

Generally, a pre-emulsion, in which the protein is dissolved and/or is dispersed colloidally is produced with the at least one water-soluble protein with water.

The water-soluble protein can be a plant protein isolate, e.g. isolated leguminous plant protein, e.g. pea protein, or isolated hydrolysed protein from grain, especially isolated wheat protein, gelatine, albumen, preferably milk protein, e.g. skim milk, especially skim milk powder, preferably reduced in lactose or lactose-free, or a mixture of at least two of these. The water-soluble protein can be present as a powder or contain water.

The fat at least in admixture with the emulsifier is emulsifiable in water which can have a temperature of 25° C. to 90° C., e.g. 30° C. to 75° C. The fat preferably is a fat or oil which is liquid at 5° C. to 90° C., respectively at its melting temperature up to 90° C., e.g. selected among animal and plant fats, e.g. fishoil, especially salmon oil, butter, butterfat, coconut fat, cocoa butter, palm oil and mixtures of at least two of these.

The emulsifier preferably comprises mono- and diglycerides of food fatty acids, egg yolk, which optionally is hydrolyzed enzymatically, e.g. by means of phospholipase A2 or D, or a mixture of at least two of these, or consists thereof.

The finely divided foodstuff which prior to mixing into water can be a pourable powder, a pasty or liquid preparation, in admixture with water preferably has particle sizes of at maximum 500 μm, more preferably at maximum 250 μm, or forms a colloid or a solution. The finely divided foodstuff can e.g. be fish powder, meat powder, sausage for spreading, meat extract, plant powder, e.g. fruit powder or fruit pulp, cheese powder, processed cheese or mixture of at least two of these. Optionally, the mixture of the finely divided foodstuff with water, optionally with maltodextrin, has a temperature of 5° C. to 90° C., e.g. 15° C. to 75° C.

The maltodextrin has e.g. chain length of 7 to 12 glucose units.

The process has the advantage to produce an ice mix from which by means of a freezer an ice mass can be produced which can contain introduced gas, e.g. air or nitrogen, as overrun and which has a crystal size suitable for ice-cream and from which by means of a cooled planetary roller extruder a frozen ice mass can be produced. The freezer can be a

conventional freezer, in which scrapers move the ice mix along a cooled surface and remove ice mix that is frozen to the cooled surface.

The ice mix therefore preferably does not contain freezing point depressing ingredients, especially sugar to at maximum 1 wt.-%, preferably at maximum 0.5 wt.-% or no sugar, further preferably no alcohol and no glycerol.

Optionally the ice mix can contain sweetening agents, e.g. peptide-sweeteners or stevia glycosides, and/or sugar alcohols, e.g. isomalt, xylit and/or erythrit. Preferably, especially in the use of the process, respectively in the use of the ice-cream produced thereby as animal feed, neither the ice mix nor the coating mass contains sugar or sugar alcohol, nor sweetening agent.

As a less preferred alternative to cooling by a planetary roller extruder the ice mass can be dispensed into forms, can be frozen further in the forms and subsequently be removed from the forms.

The portioning of the frozen ice mass preferably occurs into pieces which are mouth-sized, e.g. having a volume of 0.5 mL to 7 mL, or preferred up to 5 mL or up to 3 mL. Following the further cooling by means of a planetary roller extruder the portioning occurs e.g. by cutting the extrudate into pieces of predetermined length.

The coating of the pieces of frozen ice mass is preferred in order to reduce adhering of the pieces to one another. Optionally, the coated pieces of frozen ice mass can be packaged loosely in bags or cartons, and upon storage below −5° C., preferably below −10° C., can be separated easily from one another and can be removed singly, respectively do not adhere to one another.

The coating can e.g. occur by spraying the pieces of frozen ice mass with the coating mass, or by conveying the pieces through a bath of the coating mass and/or conveying the pieces through a curtain of coating mass streaming downwards.

Subsequent to the coating, the coated pieces are cooled, preferably separated, respectively arranged on a carrier without contact to one another, e.g. to a temperature in the range of −18° C. to −40° C.

The ice mix and the optional coating mass are free from stabilizer, especially free from a stabilizer from the group comprising guar flour, locust bean flour, xanthan and carboxymethyl cellulose or mixtures of at least two of these.

The ice mix, respectively the ice-cream produced therefrom by cooling, and optionally the coating mass comprise or consist of a high pressure homogenized emulsion, which contains or consists of at least one water-soluble protein, water, at least one fat and an emulsifier,

optionally colorant, and in admixture with this emulsion a mixture which contains or consists of at least one finely divided foodstuff, finely dispersed in water, optionally maltodextrin and/or colorant,

optionally coated by a coating mass.

In the ice mix, the water-soluble protein is contained e.g. to 5 to 20 wt.-%, preferably 7 to 10 wt.-%,

the fat e.g. to 5 to 15 wt.-%, preferably 6 to 12 wt.-%,

the emulsifier, especially mono- and diglycerides of food fatty acids, e.g. to 0.2 to 0.8 wt.-%, preferably 0.4 to 0.6 wt.-%,

the finely divided foodstuff e.g. to 1 to 30 wt.-%, preferably 2 to 20 wt.-%,

the optional maltodextrin is contained e.g. to 5 to 15 wt.-%, preferably to 10 to 12 wt.-%, remainder water,

each in relation to the ice mix, or the ice mix consists thereof.

The invention is now described in greater detail by way of examples, which relate to ice-cream which finds use as animal feed, especially as catfood, and with relation to the figure which
schematically shows the process.

The figure shows that preferably the water-soluble protein is dissolved in water prior to mixing it with the fat at a temperature above its melting point and emulsifier, to produce the pre-emulsion. The pre-emulsion is converted to the emulsion by the high pressure homogenization, which emulsion subsequently is mixed with the finely divided foodstuff and optionally maltodextrin in order to produce the ice mix. Therein it is shown, as generally preferred, that the finely divided foodstuff firstly is mixed with water in order to produce an aqueous mixture. This aqueous mixture can be a suspension, a colloidal mixture or a solution of the finely divided foodstuff, optionally also of the maltodextrin, in water. The emulsion is at least partially pasteurized by the high pressure homogenization. Therefore it is preferred not to subject the emulsion obtained to a germ-reducing treatment and optionally not to add a preservative agent to the emulsion. Preferably, the finely divided foodstuff, water and optionally maltodextrin are pasteurized, respectively that these ingredients are low in germs, preferably pasteurized, and are mixed with the emulsion. The ice mix can optionally be pasteurized.

The ice mix is frozen under motion in the freezer to a pumpable ice mass and is provided with overrun. Preferably the ice mass directly subsequent to the freezer is cooled further by means of a cooled planetary roller extruder to a frozen ice mass and subsequently is portioned into pieces. The pieces of frozen ice mass produced in this way are preferably coated with a coating mass in order to produce coated pieces. Preferably the coating mass is an aqueous composition, which corresponds e.g. to the ice mix, to the emulsion, or to an aqueous mixture of the finely divided foodstuff in water, optionally with maltodextrin, wherein the water-soluble protein and/or the finely divided foodstuff can be the same as in the ice mix itself or can be another protein and/or another finely divided foodstuff.

### EXAMPLE 1

### Production of Ice with Salmon Flavour for Use as Animal Feed

For sugar-free ice-cream which found use as animal feed for cats, as a water-soluble protein 6.4 kg (8 wt.-%) lactose-reduced skim milk powder was dissolved in water.

A mixture of 8.4 kg (10.5 wt.-%) salmon oil as fat with 0.4 kg (0.5 wt.-%) and mono- and diglycerides of food fatty acids (Cremodan Hi-Whip IN 840, DuPont) as emulsifier and water were mixed by means of a propeller stirrer at 500 rpm and homogenized at 50 bar (APV LAB60) in order to produce a pre-emulsion. This pre-emulsion was pressure-released over 2,500 to 3,000 bar in one step through a nozzle (Standstead Fluid Power, England) and thereby high pressure-homogenized to an emulsion. To this emulsion, a mixture of 2.24 kg (2.8 wt.-%) salmon powder (92% protein) as the finely divided foodstuff and 2.24 kg (2.8 wt.-%) maltodextrin (IN 1146 C* Dry MD01958, available from Cargill) was added to water and mixed in, in order to produce an ice mix. The total contents of water in the ice mix was 54.4 kg (68 wt.-%).

In a freezer having a scraping stirring device the ice mix was cooled to ice mass of approximately −4° C. and directly subsequently was cooled further to frozen ice mass in a planetary roller extruder having a cooled rotor and a cooled jacket and after exiting was cut into cylindrical pieces of circa 1 cm diameter and 1.5 cm length. The pieces were coated with the mixture of the salmon powder with maltodextrin in water, to which a colorant on the basis of red beet was added, as a coating mass. To this end, the pieces were conveyed on a grid belt through a curtain of the coating mass. Subsequently, the coated pieces of frozen ice mass on a conveyor belt were separately cooled to −20° C. and filled into bags.

After storing at −18° C. the coated pieces could be taken singly from the bag and within the hard-frozen coating had a core of ice mass having overrun.

### EXAMPLE 2

### Production of Ice Mass with Cheese Flavour for Use as Animal Feed

Sugar-free ice-cream that found use as animal feed for cats was pre-emulsified in accordance with example 1 of 5.25 kg (10.5 wt.-%) sunflower oil as fat and 0.25 kg (0.5 wt.-%) mono- and diglycerides of food fatty acids (Cremodan Hi-Whip) as emulsifier with 4 kg (8 wt.-%) lactose-reduced skim milk powder in water in order to produce the pre-emulsion, which subsequently was high pressure-homogenized. The emulsion produced this way was mixed with a mixture of 4 kg (8 wt.-%) maltodextrin and 9 kg (18 wt.-%) processed cheese as finely divided foodstuff which was finely dispersed in water (ca. 50° C.) by means of a mixer, in order to produce the ice mix. The total water content in the ice mix was 27.5 kg (55 wt.-%). In accordance with example 1 the ice mix was frozen in a freezer to ice mass and subsequently was cooled further in a planetary roller extruder, cut into pieces and coated with coating mass. The coating mass could be the coating mass of example 1 or the mixture having processed cheese with an addition of curcuma as colorant.

### EXAMPLE 3

### Production of Ice Having Liver Sausage Flavour for Use as Animal Feed

Sugar-free ice-cream, which found use as animal feed for cats in accordance with example 1 was pre-mixed of 3.25 kg (6.5 wt.-%) sunflower oil as fat and 0.25 kg (0.5 wt.-%) mono- and diglycerides of food fatty acids (Cremodan Hi-Whip) as emulsifier, pre-emulsified with a solution of 3.25 kg (9.8 wt.-%) lactose-reduced skim milk powder in water and high pressure-homogenized homogenized at 3,500 bar to an emulsion. The emulsion was mixed to an ice mix with a mixture of fine liver sausage and 5.1 kg (10.2 wt.-%) maltodextrin (IN 1146C* Dry MD 01958, obtainable from Cargill) in water, produced by means of a mixer. The ice mix contained 27.5 kg (55 wt.-%) water. In accordance with example 1 the ice mix was cooled to frozen ice mass and was coated with the aqueous mixture of liver sausage and maltodextrin with added colorant of roasted, finely ground cereals as coating mass.

### EXAMPLE 4

### Production of Ice with Salmon Flavour for Use as Animal Feed

Example 1 was reproduced, with replacing the skim milk powder for albumen powder or gelatin. Also the ice mix produced with albumen powder or gelatin as the water-soluble protein resulted in an acceptable ice mass.

The examples show that the process can produce ice-cream without sugar and without stabilizer in addition to the emulsifier. The total contents of sugar is only based on the skim milk powder, respectively albumen powder or the gelatin and lies below 0.5 wt.-% in the ice mix, respectively in the ice mass.

1. Process for producing ice-cream which contains at maximum 1 wt.-% sugar with the steps of
producing a pre-emulsion having at least one water-soluble protein and water, at least one fat and at least one emulsifier, optionally a colorant,
high pressure emulsifying the pre-emulsion by releasing a pressure difference of at least 1,500 bar for producing an emulsion,
mixing the emulsion with at least one finely divided foodstuff, which optionally is contained in a mixture with water containing maltodextrin, for producing an ice mix,
optionally pasteurizing the ice mix,
cooling the ice mix under motion, especially by scraping the ice mix from a cooling surface, preferably with introducing gas, for producing an ice mass,
with subsequent further cooling of the ice mass for producing a frozen ice mass,
portioning the frozen ice mass for producing pieces from the frozen ice mass.

2. Process for production according to claim 1, characterized in that the further cooling of the ice mass and the portioning occurs by means of a cooled planetary roller extruder and cutting of the extrudate into frozen pieces.

3. Process for production according to claim 1, characterized in that the finely divided foodstuff prior to mixing with the emulsion is contained in a mixture which contains or consists of the at least one finely divided foodstuff mixed in and/or finely dispersed in or dissolved in water, optionally maltodextrin and optionally a colorant.

4. Process for production according to claim 1, characterized in that the pieces of the frozen ice mass are coated with a coating mass which is only water, an aqueous mixture of at least one finely divided foodstuff in water, optionally with maltodextrin, or which consists of the ice mix, to which at least one colorant is added, with subsequent cooling of the coated pieces.

5. Process for production according to claim 1, characterized in that the pressure difference amounts to 2,500 to 3,000 bar.

6. Process for production according to claim 1, characterized in that the mixture of the at least one finely divided foodstuff in water contains maltodextrin and optionally a colorant.

7. Process for production according to claim 1, characterized in that the further cooling of the ice mass occurs by means of a cooled planetary roller extruder.

8. Process for production according to claim 1, characterized in that the water-soluble protein consists of milk protein, gelatin, albumen and/or plant protein isolate.

9. Process for production according to claim 1, characterized in that the emulsifier consists of mono- and diglycerides of food fatty acids and/or egg yolk.

10. Process for production according to claim 1, characterized in that the ice-cream in addition to the emulsifier does not contain a stabilizer.

11. Process for production according to claim 1, characterized in that in addition to the emulsifier no synthetic ingredients are added to the ice-scream.

12. Process for production according to claim 1, characterized in that the ice mix, respectively the ice-cream produced therefrom by cooling, and the optional coating mass consist of a high pressure-homogenized emulsion, which consists of at least one water-soluble protein, water, at least one fat and an emulsifier, optionally colorant, and in admixture with the emulsion a mixture consisting of at least one finely divided foodstuff that is finely dispersed in water, optionally maltodextrin and/or colorant.

13. Process for production according to claim 1, characterized in that at least one sweetening agent, which is a peptide-sweetener or stevia glycoside and/or sugar alcohol, is added to the pre-emulsion and/or to the mixture of the at least one finely divided foodstuff with water and/or to the ice mix.

14. Process for production according to claim 1, characterized in that the finely divided foodstuff is selected from the group comprising or consisting of fish powder, meat powder, sausage meat, sausage for spreading, meat extract, plant powder, e.g. fruit powder or fruit pulp, cheese powder, processed cheese, or mixture of at least two of these.

15. Process for production according to claim 1, characterized in that the colorant is selected from the group consisting of curcuma, red beet and a roasted, finely ground cereals.

16. Ice-cream that at maximum contains 1 wt.-% sugar, obtainable according to claim 1.

17. Ice-cream according to claim 16, characterized in that it consists of a frozen mixture having overrun of a high pressure-homogenized emulsion which comprises or consists of at least one water-soluble protein, water, at least one fat and an emulsifier, optionally colorant, with a mixture which contains or consists of at least one finely divided foodstuff finely dispersed in water, optionally maltodextrin and/or colorant.

18. Use of an ice-cream according to claim 16 as feed for cats.
